(19) United States
(12) Patent Application Publication
(10) Pub. No.: US 2016/0243902 A1
(43) Pub. Date: Aug. 25, 2016

(54) EVERSIBLE TIRE

(71) Applicant: ALI A. A. J. SHAMMOH, AL-ADEN (KW)

(72) Inventor: ALI A. A. J. SHAMMOH, AL-ADEN (KW)

(21) Appl. No.: 14/631,757

(22) Filed: Feb. 25, 2015

(51) Int. Cl. B60C 19/00; B60C 11/00

(52) U.S. Cl. CPC B60C 19/00; B60C 11/005

(57) ABSTRACT

The eversible tire includes a casing having a first surface and a second surface opposite the first surface. The casing includes laterally opposed first and second sidewalls. The first sidewall has a bead edge and an opposed outer edge. The second sidewall has corresponding inner and outer edges. A first bead is disposed along the bead edge of the first sidewall. The first bead has first and second lateral extensions. A second bead is disposed along the bead edge of the second sidewall. The second bead has corresponding first and second lateral extensions in mirror image to the extensions of the first bead. Each of the beads are laterally symmetrical with respect to the first and second surfaces of the casing to permit the eversible tire to be installed upon a wheel with either its first surface and first tread or its second surface and second tread facing outward.

### BACKGROUND OF THE INVENTION

1. Field of the Invention

The present invention relates to wheels, tires, and the like, and particularly to an eversible tire permitting the casing and integral tread to be everted to use a second tread when the first tread is worn.

2. Description of the Related Art

The construction of the conventional pneumatic tire and its installation with a conventional wheel are well known. Such tires have casings, laterally opposed beads with sidewalls extending radially outward from the casings, and a tread extending laterally across the outer edges of the sidewalls. The beads are configured to fit tightly within the outer rims of a mating wheel to provide a secure installation. The beads of tubeless tires sealing so well with the wheel rims that practically no air can escape. Development over the years has resulted in quite good durability and reliability for such tire construction.

Nonetheless, the problem of eventual tread wear remains. The tire beads and sidewalls will remain in relatively good condition throughout the life of a conventional tire, if not subjected to undue abuse, with tire life being limited according to tread wear. As the tread is the only component of the tire that engages frictionally with another surface, the tread is usually the only component that actually wears away during tire use. While rubber and elastomer compounds have been developed that increase tread wear considerably, the tread is always the first component to wear out in a conventional tire in normal use, so long as the sidewalls of the tire remain undamaged.

When the tread is worn out on a conventional tire, the remainder of the tire carcass or casing is essentially worthless trash and must be disposed of, unless it is recapped with a new tread. The disposal of the essentially undamaged carcass of the tire due to only the tread being worn out, is clearly not an environmentally sound practice. While recapping has been proven to be reasonably successful in many areas, some find that recapped tires are not as reliable as new tires. Additionally, the recapping process renders the vehicle unusable for some time while its tires are being recapped.

As a result, there has been some experimentation and development of tires having more easily replaceable treads. An example is found in Chinese Patent Publication No. 102729734 published on Oct. 17, 2012 to Huang Baiyuan. This reference describes (according to the drawings and English abstract) a tire having a replaceable tread,

Thus, an eversible tire solving the aforementioned problems is desired.

### SUMMARY OF THE INVENTION

The eversible tire comprises a casing having laterally opposed first and second sidewalls with a tread base extending across the outer edges of the sidewalls and circumferentially around the sidewalls. Each sidewall has a bead extending circumferentially around its inner edge. This construction can be unitary, i.e., the sidewalls with their beads and the tread base can be formed as a single, unitary component at the time of manufacture.

The opposed first and second surfaces extend radially from one bead over the first sidewall, laterally across the tread base and its tread, and over the second sidewall to the opposite bead. When the eversible tire is installed upon a wheel, one of these surfaces is exposed to the volume contained within the tire and its wheel, and the other surface is exposed to the outside of the tire. Each of the sidewall beads is laterally symmetrical, permitting the beads to seat tightly against the rim of the wheel regardless of the orientation of the tire surfaces to the inside or to the outside of the tire.

The tread base of the eversible tire casing is equipped with a tread disposed upon both its first and second surfaces, i.e., two mutually opposed treads. (The term “tread base” is used herein to define the structural portion of the tire that underlies the tread proper that is worn away during use.) The two treads are molded or otherwise permanently formed integrally with the tread base and the remainder of the tire casing at the time of manufacture of the tire and are not removable from the remainder of the tire except through normal wear or abrasion. The construction of the eversible tire with its two opposed treads and laterally symmetrical beads permits the eversible tire to be everted, i.e., turned inside out, when the outer tread has been worn away. This places the worn tread to the inside of the tire and places the previously unexposed tread to the outer surface of the tread base and tire, thus essentially doubling the wear and life of the tire while retaining most of the original tire construction and obviating the need to discard the tire when the first tread has been worn away.

These and other features of the present invention will become readily apparent upon further review of the following specification and drawings.

### BRIEF DESCRIPTION OF THE DRAWINGS

FIG. 1 is a perspective view of an eversible tire according to the present invention, illustrating its general configuration.

FIG. 2 is a perspective view in section of the eversible tire according to the present invention, illustrating further features thereof.

FIG. 3 is a perspective view in section of the eversible tire according to the present invention, illustrating an exemplary installation on a conventional vehicle wheel.

FIG. 4 is a perspective view of an alternative embodiment of the eversible tire according to the present invention, with the tire having different tread patterns for its two opposite treads.

Similar reference characters denote corresponding features consistently throughout the attached drawings.

### DETAILED DESCRIPTION OF THE PREFERRED EMBODIMENTS

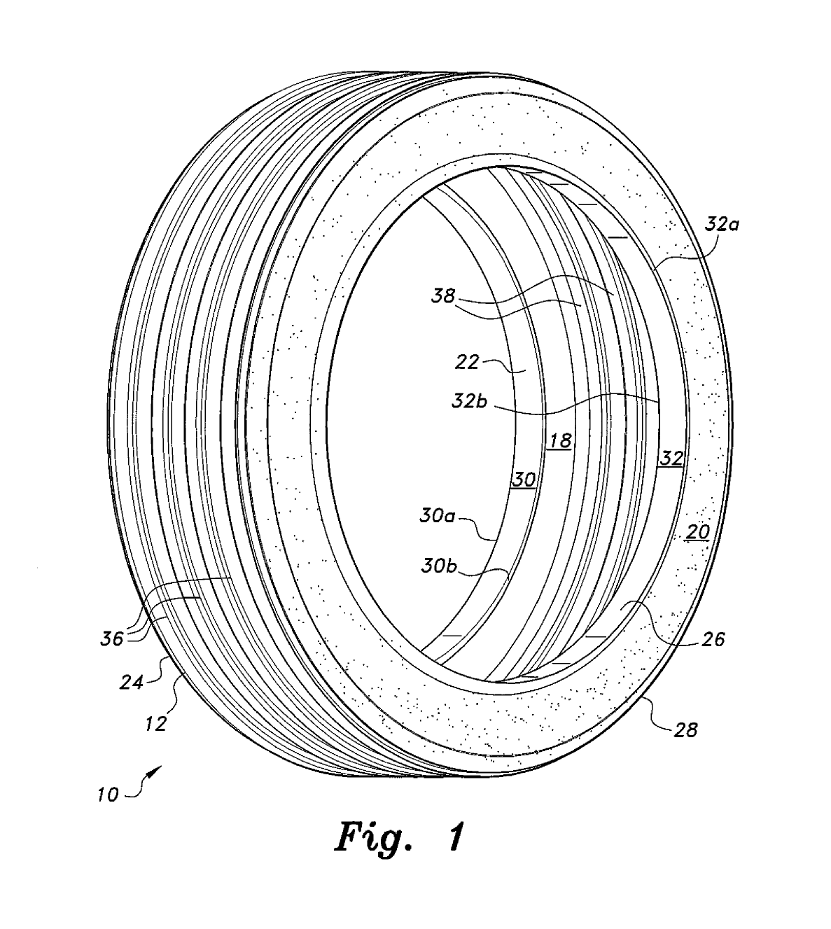

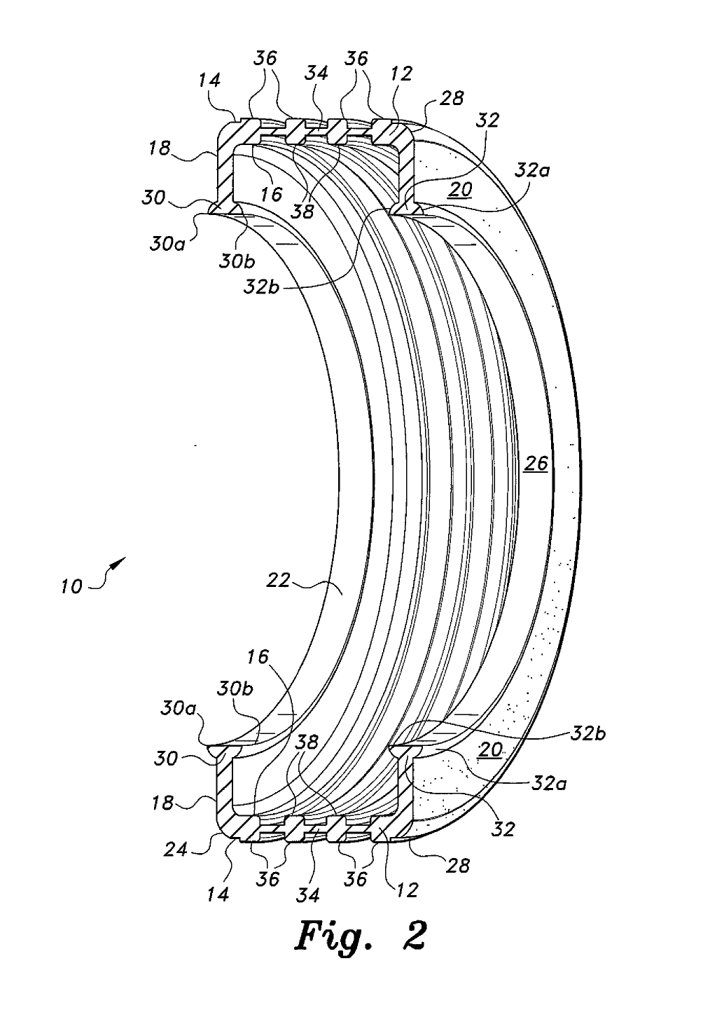

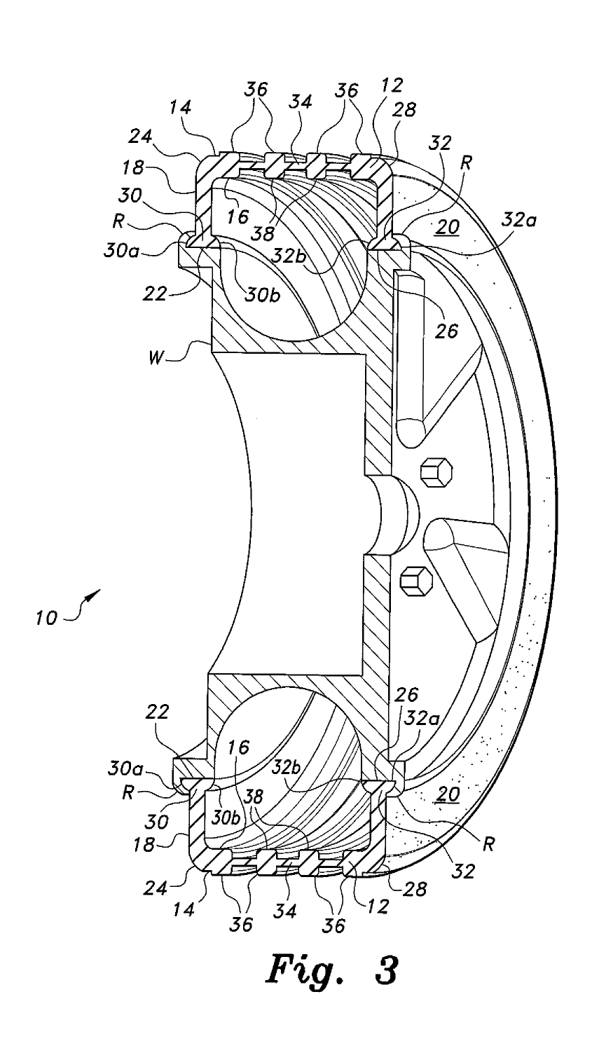

The eversible tire includes a tire with usable treads disposed upon opposing surfaces of the tire, thus essentially doubling the life of the tire when the casing is everted. FIG. 1 of the drawings provides a perspective view of an exemplary eversible tire 10, with FIG. 2 illustrating the eversible tire 10 in section and FIG. 3 providing a view of the eversible tire 10 in section in combination with a wheel W. The specific structure of the wheel W depicted in FIG. 3 is exemplary; any practicable wheel configuration may be used with the eversible tire in its various embodiments.

The sectional views of FIGS. 2 and 3 provide the best views to show the structure of the eversible tire 10. The eversible tire 10 essentially includes a casing 12 having a first surface 14 and a second surface 16 opposite the first surface 14. The casing 12 includes mutually laterally opposed first and second sidewalls, respectively 18 and 20. The first sidewall 18 can be parallel to the second sidewall 20. The first sidewall 18 has an inner edge or bead edge 22 and a radially opposed outer edge or shoulder edge 24. The second sidewall 20 has corresponding inner and outer edges, respectively 26 and 28. A first bead 30 is disposed circumferentially along the inner or bead edge 22 of the first sidewall 18, with a second bead 32 disposed circumferentially along the inner or bead edge 26 of the second sidewall 20. It will be noted that each of the beads 30 and 32 is laterally symmetrical with respect to the first and second surfaces 14 and 16 of the casing 12. In other words, beads 30 and 32 are laterally symmetrical irrespective of the orientation of the tire surfaces 14 and 16. The first bead 30 has first and second lateral extensions 30a and 30b. The first lateral extension 30a can extend substantially normal to the first sidewall 18 in a first direction. The second lateral extension 30b can extend substantially normal to the first sidewall 18 in a second direction that is opposite the first direction. The second bead 32 has corresponding first and second lateral extensions 32a and 32b in mirror image to the extensions of the first bead 30. The laterally symmetrical beads 30 and 32 permit the eversible tire 10 to seat upon the two laterally opposed circumferential wheel rims R (FIG. 3) regardless of the orientation of the first and second surfaces 16 and 18. The various beads 30, 32 and bead extensions 30a, 30b, 32a, 32b, and the wheel rim R, are preferably formed to provide an essentially airtight seal therebetween when the eversible tire 10 is installed upon the wheel W of FIG. 3, thus obviating the need for a separate tube within the wheel and tire assembly. However, a separate tube may be installed within the wheel and tire assembly when the eversible tire 10 is installed on the wheel W. The relatively soft and pliable nature of the tube allows it to settle between the various raised tread components of the inner tread in such an installation.

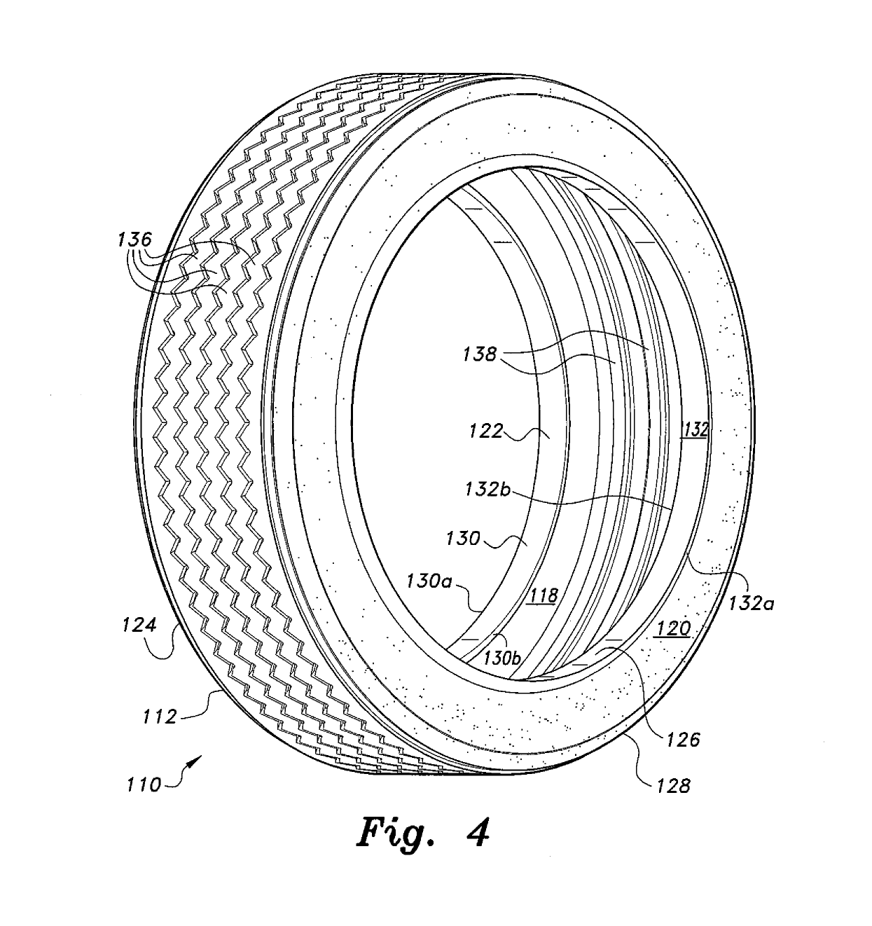

The eversible tire 10, or more specifically the casing 12 thereof, further includes a circumferential tread base 34 that extends laterally across and connects the outer or shoulder edges 24 and 28 of the two sidewalls 18 and 20 to one another. A first tread 36 is disposed upon the first surface 14 of the tread base 34, with a second tread 38 disposed upon the opposite second surface 16 of the tread base 34. The two treads 36 and 38 may be identical to one another as shown in FIGS. 1 through 3, or may be different from one another as shown in FIG. 4 and described further below. The various components of the eversible tire 10, e.g., the first and second treads 36 and 38, the tread base 34, the first and second sidewalls 18 and 20, and the first and second beads 30 and 32 can be formed as a unitary structure and may include various belts, plies, cords, etc., as is known in the field of tire construction.

FIG. 4 provides a perspective view of an alternative embodiment of the eversible tire, designated as eversible tire 110. The eversible tire 110 essentially includes all of the various components and features of the eversible tire 10 of FIGS. 1 through 3, i.e., a casing 112, mutually opposed first and second surfaces 114 and 116, laterally mutually opposed first and second sidewalls 118 and 120, first sidewall inner and outer edges 122 and 124, second sidewall inner and outer edges 126 and 128, first sidewall bead 130 and its laterally symmetrical extensions 130a and 130b, second sidewall bead 132 and its laterally symmetrical extensions 132a and 132b, and a tread base 134 with opposite first and second treads 136 and 138 thereon. It will be seen in FIG. 4 that the eversible tire 110 has a patterned first tread 136, i.e., the tread having alternating staggered grooves and raised tread areas, with the second tread pattern 138 comprising a series of smooth circumferential ribs. It will be understood that the specific tread patterns are not critical to the invention, and that any identical or dissimilar first and second treads 36, 38 or 136, 138 may be used upon either the first or second surfaces of the present eversible tires 10 or 110 as desired.

The eversible tires 10 and 110 are used by installing the tire 10 or 110 on a wheel W with either the first tread 36 or 136 facing outward and the second tread 38 or 138 facing inward, as shown in FIG. 3, or with the second tread 38 or 138 facing outward and the first tread 36 or 136 facing inward, as desired. When the outward facing tread has been worn away through use or damage, the eversible tire 10 or 110 may be removed from the wheel W and everted to place the previously inward facing unworn tread to the outside and the worn or damaged tread to the inside. The eversible tire 10 or 110 is then reinstalled on the wheel and is ready for further use, essentially providing the tread life of a new tire. It will be seen that this provision of two treads on the opposite surfaces of the eversible tire essentially doubles the life of the tire, thus providing significant advantages in operating economy and environmental considerations.

It is to be understood that the present invention is not limited to the embodiments described above, but encompasses any and all embodiments within the scope of the following claims.

1-15. (canceled)

16. A tubeless eversible tire, comprising:
a unitary casing having a first surface and a second surface opposite the first surface, the unitary casing comprising:
a first sidewall and a second sidewall laterally opposite the first sidewall, each sidewall having an inner edge and an outer edge;
a first bead disposed circumferentially about the inner edge of the first sidewall, the first bead having a first lateral extension and a second lateral extension oppositely disposed thereon, the first lateral extension and the second lateral extension of the first bead axially extending normally to first sidewall;
a second bead disposed circumferentially about the inner edge of the second sidewall, the second bead having a first lateral extension and a second lateral extension oppositely disposed thereon, the first lateral extension and the second lateral extension of the second bead axially extending normally to second sidewall;
wherein the first bead and the first lateral extension and the second lateral extension of the first bead define a semi-circular cross-sectional shape;
wherein the second bead and the first lateral extension and the second lateral extension of the second bead have a semi-circular cross-sectional shape;
a circumferential tread base connecting the outer edge of the first sidewall to the outer edge of the second sidewall;
a first tread disposed upon the first surface of the tread base; and
a second tread disposed upon the second surface of the tread base.

17. The eversible tire according to claim 16, wherein:
the first tread consisting of a first tread pattern; and
the second tread consisting of a second tread pattern.

18. The eversible tire according to claim 16, wherein:
the first tread includes a first tread pattern; and
the second tread includes a second tread pattern, the first tread pattern being identical to the second tread pattern.

19. The eversible tire according to claim 16, wherein:
the first tread includes a first tread pattern; and
the second tread includes a second tread pattern, the first tread pattern being different from the second tread pattern.

20. An eversible tire, consisting of:
a unitary casing having a first surface and a second surface opposite the first surface, the unitary casing comprising:
a first sidewall and a second sidewall laterally opposite the first sidewall, each sidewall having an inner edge and an outer edge;
a first bead and a first pair of extensions, laterally symmetrical and forming a semi-circular cross-sectional shape with the first bead, disposed circumferentially about, and extending normally to the inner edge of the first sidewall;
a second bead and a second pair of extensions, laterally symmetrical and forming a semi-circular cross-sectional shape with the second bead, disposed circumferentially about, and extending normally to the inner edge of the second sidewall; and
a circumferential tread base connecting the outer edge of the first sidewall to the outer edge of the second sidewall;
wherein the circumferential tread base having a first surface and a second surface;
the circumferential tread base consists of a first tread having a first tread pattern disposed upon the first surface of the tread base, and a second tread having a second tread pattern disposed upon the second surface of the tread base;
wherein the tread base, the first sidewall, the second sidewall, the first bead, and the second bead being formed as a unitary structure.

21. The eversible tire according to claim 20, wherein the eversible tire is tubeless.

22. The eversible tire according to claim 20, wherein the first tread pattern being identical to the second tread pattern.

23. The eversible tire according to claim 20, wherein the first tread pattern being different from the second tread pattern.

24. An eversible tire and wheel system comprising:
a casing having a first surface and a second surface opposite the first surface, the casing consisting of:
a first sidewall and a second sidewall laterally opposite the first sidewall, each sidewall having an inner edge and an outer edge;
a first bead disposed circumferentially about the inner edge of the first sidewall;
a second bead disposed circumferentially about the inner edge of the second sidewall;
wherein each of the first and second beads each consisting of a pair of laterally symmetrical extensions, defining a semicircular form with the corresponding bead, and disposed normally with respect to the first surface and the second surface of the casing about the respective first and second sidewalls;
a circumferential tread base connecting the outer edge of the first sidewall to the outer edge of the second sidewall;
a first tread including a first tread pattern disposed upon the first surface of the tread base;
a second tread including a second tread pattern disposed upon the second surface of the tread base;
wherein the first tread, the second tread, the tread base, the first sidewall, the second sidewall, the first bead, and the second bead being formed as a unitary structure; and
a wheel having a circumferential first rim and a circumferential second rim laterally opposite the first rim, each bead of the tire seating along a respective rim of the wheel;
wherein upon disposing the casing upon the wheel, system is tubeless.

25. The eversible tire and wheel system according to claim 24, wherein the first tread pattern being identical to the second tread pattern.

26. The eversible tire and wheel system according to claim 24, wherein the first tread pattern being different from the second tread pattern.
